(19) United States
(12) Patent Application Publication
(10) Pub. No.: US 2006/0035547 A1
(43) Pub. Date: Feb. 16, 2006

(54) Thermo-adhesive mesh

(76) Inventor: Thierry Gautreau, Cremieu (FR)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/509,582

(22) PCT Filed: Apr. 3, 2003
(86) PCT No.: PCT/FR03/01047

§ 371 Date: Aug. 9, 2005

(30) Foreign Application Priority Data
Apr. 3, 2002 (FR) 02/04185

(51) Int. Cl. B32B 27/12; D04H 1/00; B32B 27/04; B32B 27/02; B32B 17/02; B32B 5/12; B32B 5/02; B32B 17/04

(52) U.S. Cl. 442/58; 442/50; 442/149; 442/164; 442/180

(57) ABSTRACT

The present disclosure relates to a textile scrim (5A) formed by a network of nonwoven crossed yarns. The scrim comprises at least one ply of warp yarns (1, 1′) and at least one ply of weft yarns (2). The warp yarns (1, 1′) and weft yarns (2) are bonded together by a bonding agent (3). The textile scrim (5A) is coated on at least one of its faces (A) with a thermally reactive adhesive (3) in order to laminate the scrim (5A) onto an external element. The viscosity of the adhesive (3), measured at a temperature of 230^{c} C. according to the ASTM-D3236-8 8 standard, is less than or equal to 40 Pa.s.

### TECHNICAL FIELD

The present invention relates to the general technical field of textile scrims formed from a network of warp and weft yarns, such scrims being used in particular as reinforcements or supports in various industrial applications.

The present invention relates to a textile scrim formed by a network of nonwoven crossed or superposed yarns, comprising at least one ply of warp yarns and at least one ply of weft yarns, the warp yarns and weft yarns being bonded together by a bonding agent, said textile scrim being coated on at least one of its faces with a thermally reactive adhesive in order to laminate the scrim onto an external element, for example with a view to reinforcing it.

The present invention also relates to any finished or unfinished industrial product that incorporates a textile scrim according to the invention.

The present invention also relates to a process for manufacturing a textile scrim, in which a network of crossed or superposed nonwoven yarns, comprising at least one ply of warp yarns and at least one ply of weft yarns, is produced in order to form a bare scrim and in which at least one of the faces of said bare scrim is coated with thermally reactive adhesive.

Finally, the present invention relates to a device for implementing at least part of the abovementioned process.

### PRIOR ART

It is already known to produce scrims on an industrial scale that are formed from a network of nonwoven crossed yarns, the yarns being bonded together at their points of intersection by impregnation with a bonding agent, of the thermoplastic adhesive kind or the like. The known scrims may, for example, employ at least two plies of warp yarns that are superposed or even offset, each pair of plies having, interposed between them, at least one ply of weft yarns.

In these known constructions, the warp yarns and weft yarns are bonded together at their intersections by a bonding agent, creating a series of bonding points, with a view to obtaining a textile scrim having a finished structure that is stable from the mechanical standpoint.

The scrims produced using this technique are generally satisfactory and are used for reinforcements or supports in a very wide variety of technical fields such as, for example, but not restrictedly, in the building industry as backings for parquet and ceramic floors, or wall coverings and carpets, in the paper industry, or else as reinforcement elements in synthetic foams or the like.

In general, the scrims intended to be used as reinforcements are joined, by adhesive bonding, to the surface of the element to be reinforced. Such a joining operation is also called lamination. This lamination may be carried out using an external supply of adhesive.

In particular in the case of the scrims described above, such a supply of adhesive is unnecessary—the bonding agent impregnating the scrim is capable of fulfilling this adhesive bonding function. In this case, all that is required is to position the scrim against the surface of the element to be reinforced and to thermally activate the bonding agent, using a heater, that is to say to heat it to a temperature at which it exhibits an adhesive character, thereby making it possible for the scrim to be fastened to the element to be reinforced, this fastening remaining effective once the bonding agent has returned to a temperature below the abovementioned temperature.

However, it is apparent that the textile scrims known at the present time that are impregnated with a reactive bonding agent for the purpose of lamination suffer from a number of drawbacks, and especially drawbacks associated with the relatively high temperature needed to activate the bonding agent so as to impart its adhesive character thereon.

This is because the bonding agents that have been used hitherto are generally polymeric adhesives in aqueous or solvent phase, which adhesives may or may not be crosslinked. Activating such adhesives requires temperatures of around 150° to 300° C. Such temperature levels therefore require lengthy lamination times since this depends on the time needed for the heater to reach the activation temperature, it being understood that the higher this temperature the longer the time to reach it. Such temperature levels also preclude the lamination onto certain materials that would not be able to withstand them. Thus, in particular, it is impossible to laminate such textile scrims onto synthetic foams such as those involved in the manufacture of motor vehicle seats, for example polyethylene foam or polyurethane foam. This is because such foams are generally impaired or destroyed at such temperature levels.

Finally, the higher the activation temperature the greater the amount of energy needed for this activation, requiring substantial and therefore expensive equipment. This has the result of increasing the manufacturing cost of the reinforced products obtained, which constitutes a drawback from the industrial standpoint.

### SUMMARY OF THE INVENTION

The objects of the present invention are consequently to remedy the various drawbacks of the abovementioned thermally reactive textile scrims of the prior art and to propose a novel textile scrim that has improved properties and is easy to process, and of a lower cost, said scrim being formed by a network of nonwoven crossed yarns and being coated with a thermally reactive adhesive in order to laminate the scrim onto an external element.

Another object of the invention is to propose a novel textile scrim coated with a thermally reactive adhesive that allows lamination onto most materials.

Another object of the invention is to propose a novel textile scrim coated with a thermally reactive adhesive that can improve the general mechanical strength and chemical resistance of the scrim.

Another object of the invention is to propose a novel textile scrim allowing clean and solvent-free adhesive bonding.

Another object of the invention is to propose a novel process for manufacturing a textile scrim coated with reactive adhesive, which is particularly simple and rapid to implement.

Another object of the invention is to propose a novel device for implementing the process according to the invention which makes it possible to produce scrims with high adhesive contents in a simple and rapid manner.

The objects of the invention are achieved by means of a textile scrim formed by a network of nonwoven crossed yarns, comprising at least one ply of warp yarns and at least one ply of weft yarns, the warp yarns and weft yarns being bonded together by a bonding agent, said textile scrim being coated on at least one of its faces with a thermally reactive adhesive in order to laminate the scrim onto an external element, characterized in that the viscosity of said adhesive, measured at a temperature of 230° C. according to the ASTM-D3236-88 standard, is less than or equal to 40 Pa.s.

The objects of the invention are also achieved by means of a process for manufacturing a scrim according to the invention, characterized in that it comprises at least:
a step of intersecting the warp yarns with the weft yarns in order to form a bare scrim; and
a coating step in which at least one of the faces of said bare scrim is coated with thermally reactive adhesive, the viscosity of which, measured at a temperature of 230° C. according to the ASTM-D3236-88 standard, is less than or equal to 40 Pa.s.

Finally, the objects of the invention are also achieved by a device for implementing the process according to the invention, characterized in that it comprises:
a tank intended to contain thermally reactive adhesive, the viscosity of which, measured at 230° C. according to the ASTM-D3236-88 standard, is less than or equal to 40 Pa.s, said tank being heated so as to keep the adhesive in the molten state, and having at least one opening;
a roll rotating about its axis of symmetry, said roll being arranged and positioned relative to the tank so as to be feed, continuously, owing to its rotation, with molten adhesive through said opening and to continuously deposit this molten adhesive onto the face of a textile scrim to be coated with adhesive; and
a conveying means for bringing said textile scrim substantially into contact with the roll.

### BRIEF DESCRIPTION OF THE DRAWINGS

Other objects and particular advantages of the invention will become apparent in greater detail from reading the description which follows, and from the drawings appended hereto, given purely by illustration and implying no limitation, in which:

FIG. 1 illustrates, in a sectional side view, a detail of one embodiment of the structure of a textile scrim according to the invention;

FIG. 2 illustrates, in a top view, a detail of a scrim according to the invention;

FIG. 3 illustrates in a schematic longitudinal sectional view, the principle of the construction and operation of a device for implementing the process according to the invention; and

FIG. 4 illustrates a detail, on an enlarged scale, of the device shown schematically in FIG. 3.

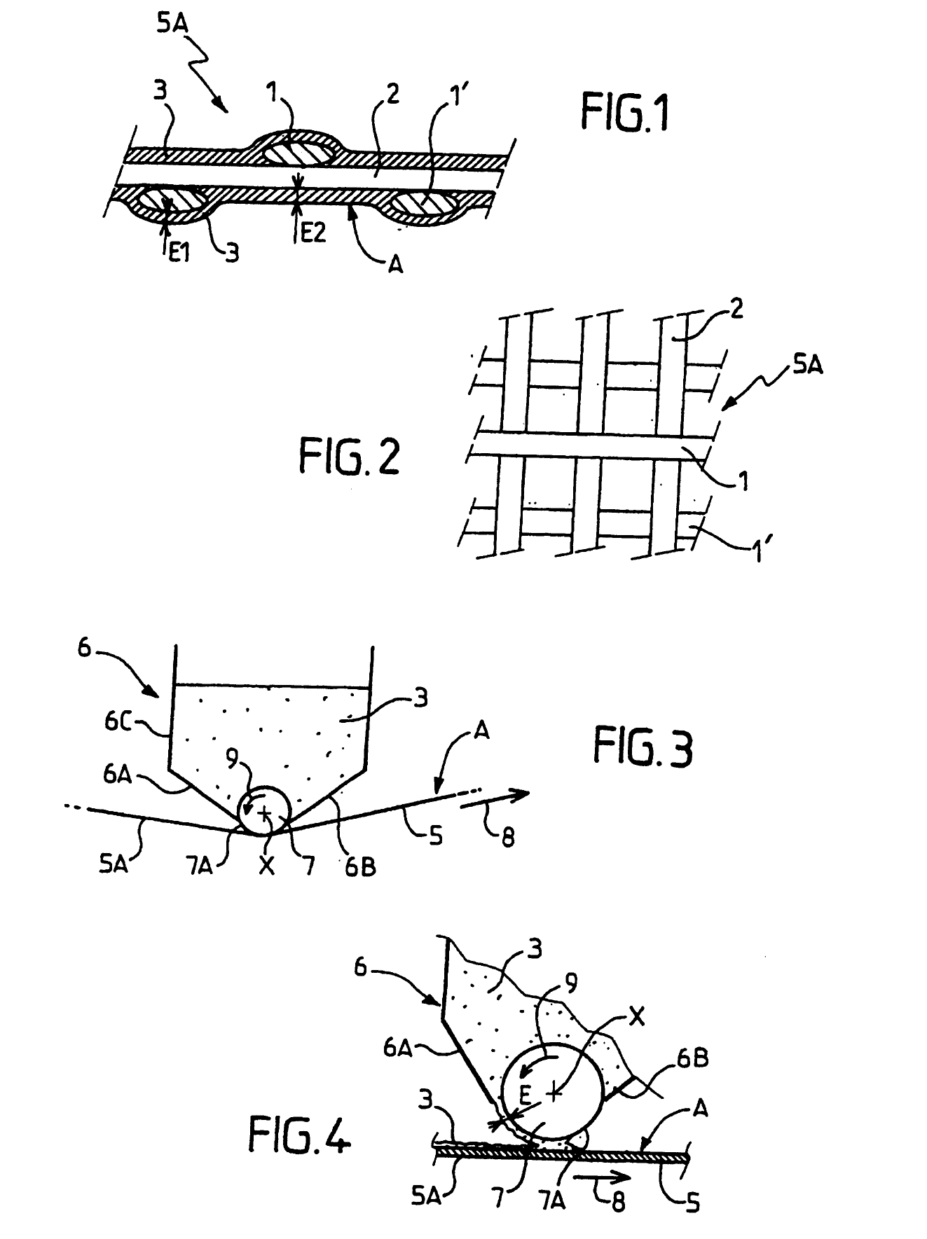

### BEST MANNER OF IMPLEMENTING THE INVENTION

According to the invention, the textile scrim 5A according to the invention is formed by a network of nonwoven crossed yarns, comprising at least one ply of warp yarns 1, 1′ and at least one ply of weft yarns 2.

The yarns thus define empty regions, in such a way that the scrim has an open structure.

Advantageously, the textile scrim according to the invention comprises at least two plies of warp yarns 1, 1′ between which at least one ply of weft yarns 2 is interposed.

As is well known to those skilled in the art, the construction of the network of warp yarns 1, 1′ and weft yarns 2 is obtained by offsetting the warp 1, 1′ and weft 2 yarns without superposition (see FIG. 2), or on the contrary with superposition of the yarns.

Similarly, the network of warp 1 and weft 2 yarns may be obtained by a 90° intersection of the warp and weft yarns (square construction), or at a different angular inclination, and for example in two directions or in three directions.

By way of nonlimiting example, the density of the textile scrim according to the invention may vary from 0.4 yarns per centimeter to 10 yarns per centimeter in the case of both the warp and weft yarns.

By way of nonlimiting example, and as is well known to those skilled in the art, any type of textile yarn commonly used at the present time for the production of textile scrims can be used, for example glass yarns (having a linear density than may vary, for example, from 11 to 554 tex) or polyester yarns (having a linear density that may vary, for example, between 78 dtex and 1100 dtex).

According to the invention, the warp 1, 1′ and weft 2 yarns are bonded together by a bonding agent that creates a series of adhesive bonding points at the intersection of the network of yarns.

Within the meaning of the invention, any bonding agent commonly used at the present time in the technical field in question may especially be used, and in particular any polymeric adhesive of the thermoplastic polymer type.

By way of nonlimiting example, the bonding of the network of yarns forming the textile scrim according to the invention may thus be carried out by synthetic lattices (SBR), PVAC, PVC plastisols, polyvinyl alcohol (PVA), conventional hot-melt impregnations, polyurethane bonding agents or acrylic bonding agents for example.

According to the invention, the textile scrim 5A is coated on at least one of its faces, A, with a thermally reactive adhesive 3 in order to laminate the scrim onto an external element.

Within the context of the invention, a thermally reactive adhesive is a material which, when subjected to a characteristic temperature called the thermal activation temperature, will exhibit an adhesive character allowing it to be fastened to an external element. This fastening is durable once the material has returned to a temperature below said thermal activation temperature.

Thus, the material forming the reactive adhesive may exhibit a nonadhesive character at room temperature and be in the solid state, whereas when it is heated to at least its thermal activation temperature it takes the form of a liquid, which may be very viscous, exhibiting bondability.

The thermal activation is performed by a heating means which may be of any known type and may, for example, employ high-frequency or infrared radiation, and conduction or even convection phenomena.

According to one essential feature of the invention, the viscosity of the adhesive 3, measured at a temperature of 230° C. according to the ASTM-D3236-88 standard, is less than or equal to 40 Pa.s.

Preferably, the viscosity of said adhesive, measured at a temperature of 200° C. according to the ASTM-D3236-88 standard, is less than or equal to 30 Pa.s.

Even more preferably, the viscosity of said adhesive, measured at its temperature of application (the value of which is automatically available from the manufacturer) according to the ASTM-D3236-88 standard, is less than or equal to 30 Pa.s.

Such a viscosity characteristic is representative of an adhesive that can react at temperatures that may be relatively low, possibly below 70° C. for example.

Thus, the textile scrim 5A according to the invention may be laminated without any damage onto materials that are not resistant to high temperatures, especially synthetic foams.

Advantageously, the adhesive 3 is of the hot-melt type. An adhesive of the hot-melt type is an adhesive that is 100% thermally fusible, also called 100% active, which comprises a thermoplastic material that can pass from a nonadhesive solid state to an adhesive viscous state, and do so reversibly. The solid state is obtained when the material is subjected to a temperature below a characteristic temperature called the thermal activation temperature, which for example may vary from between 70° and 180° C. depending on the formulation of the adhesive. When the material is subjected to this thermal activation temperature or a temperature above it, it is in the viscous and adhesive state mentioned above.

Hot-melt adhesives are well known as such and consist of a polymer compound that includes:
one or more polymers or copolymers of high molecular weight, for example polyethylene/vinyl acetate, polyamide, polyester, epoxy, polyethylene;
paraffin waxes of low molecular weight (800-1000 g/mol);
tackifying resins of the colophony type, of low molecular weight; and
additives, for example UV stabilizers or antioxidants.

They allow clean solvent-free bonding and can be used with many materials, whether cellular or not, such as polymers, including polyolefins, natural materials, metals, composites and ceramics.

Thus, the scrim according to the invention may be laminated onto most materials, so as to form a complex.

The scrim according to the invention is thus also capable of being compatible with secondary or final conversion operations carried out on the complex, such as for example thermoforming of the complex.

The textile scrim according to the invention may employ any known type of hot-melt adhesive.

The textile scrim 5A according to the invention may be covered with thermally reactive adhesive 3 on at least one of its faces with a mass per unit area (or coating weight) of between 2 and 300 g/m² for example.

Advantageously, the ratio of the mass of adhesive 3 coating the network of yarns to the mass of said network of yarns may be between 50 and 400%, and preferably between 100 and 300%.

The use of an adhesive 3 of the hot-melt type thus allows adhesive to be deposited in substantial and uniform amounts, since the adhesive 3 consists entirely of adhesive material and not an adhesive-solvent mixture.

This makes it possible to produce a substantially impermeable protective layer on the warp 1, 1′ and weft 2 yarns.

Preferably, the bonding agent for the textile scrim according to the invention is formed by said thermally reactive adhesive 3, said adhesive thus fulfilling two functions, namely
integrity of the yarns, so that the scrim has a finished structure that is stable from the mechanical standpoint (i.e. it is self-supporting, independently of any interaction with an external element); and
adhesive bonding when the scrim is used as reinforcement, and for this purpose is laminated onto the element to be reinforced.

In this situation, it is thus unnecessary to carry out a primary impregnation with the bonding agent in order to bond the warp 1, 1′ and weft 2 yarns together.

In general, the scrim according to the invention has a mechanical strength of between substantially 19 and 1970 newtons over 5 cm. Coating with a hot-melt adhesive improves the tensile strength and the tear strength of the scrim. It also improves the flexural modulus and the stiffness of the scrim.

The textile scrim 5A according to the invention may also be advantageously used as reinforcement for motor-vehicle seat foams, since the adhesive activation temperature is compatible with the temperature that such foams can withstand. This makes it possible to produce seats that are mechanically strong, while still being termed “top of the range”.

The textile scrim according to the invention may be used to replace the polyvinyl chloride reinforcements normally used for example for motor vehicle seats. Such a use has the major advantage that, when the seat burns (accidentally or at the end of life of the product), the scrim will not give off toxic substances, whereas polyvinyl fluoride gives off chlorine.

The textile scrim according to the invention will also be particularly suitable for assembling floor coverings of the tiling or parquet floor type, or for the reinforcement of wiping cloths. It may also be used for the production of crack-concealing adhesives.

The scrim according to the invention may thus be tailored to the conditions of use of the final product. It also allows the reinforced products to be recycled at the end of life, since, owing to the reversible character of the adhesive used (which character aqueous adhesives do not have), the scrim can be separated at will from the element that it reinforces.

According to the invention, the process for manufacturing a textile scrim according to the invention, and as described above, employs a series of production steps, including at least:
a step (not shown) of intersecting the warp yarns 1, 1′ with the weft yarns 2 in order to form a bare scrim 5; such a production step is well known to those skilled in the art and may for example be carried out by any appropriate method; and
a coating step (see FIGS. 3 and 4), in which at least one of the faces A of said bare scrim 5 is coated with thermally reactive adhesive 3, the viscosity of which, measured at a temperature of 230° C. according to the ASTM-D3236-88 standard, is less than or equal to 40 Pa.s, or more preferably less than or equal to 30 Pa.s when it is measured at 200° C. according to the same standard.

Preferably, the coating step is carried out immediately after the intersecting step.

Thus, after the yarn intersecting step, the scrim 5 is not self-supporting, and the coating step makes it possible to give the scrim 5 intrinsic mechanical strength and to provide it with a thermally reactive adhesive, with a view to subsequent lamination.

In this case, the thermally reactive adhesive 3 therefore acts both as bonding agent and as lamination adhesive.

Preferably, during the coating step, the warp 1, 1′ and weft 2 yarns are covered simultaneously with adhesive 3.

Advantageously, said adhesive 3 is of the hot-melt type.

Advantageously, during the coating step, the face A of the bare scrim 5 is coated with thermally reactive adhesive 3, by passing it tangentially against at least part of the lateral surface 7A of a rotating roll 7 coated with said adhesive 3 in the melt state.

The use of a roll 7 allows “roll coating” application, permitting adhesive to be deposited in a substantially homogenous and uniform manner onto the bare scrim 5, without a bead.

The use of a roll 7 makes it possible to avoid the drawbacks of the conventional technologies for coating with products of the hot-melt type, such as machines with “lipped nozzles”. Such machines, although they can be successfully used for coating closed backings, such as paper or fabric panels over large widths, they are, however, ineffective for coating, over suitable widths, open backings having a low intrinsic mechanical strength, such as a bare scrim, without bringing about adhesive beads that make the product very difficult to use.

In a variant of the process according to the invention, a primary bonding step takes place between the yarn intersecting step and the coating step. During this primary bonding step, the bare scrim 5 is impregnated with a bonding agent so as to bond the weft 2 and warp 1 yarns together. Thus, a process according to this variant employs, after the primary bonding step, a scrim possessing an intrinsic mechanical strength conferred by the primary impregnation with bonding agent; in this case, the coating step has the purpose solely of providing the scrim with a layer of thermally reactive adhesive.

The primary bonding step may be carried out by any process of the prior art that are well known to those skilled in the art.

Any bonding agent conventionally used for such an application may be employed during this step, and especially bonding agents formed by a polymeric adhesive, or those mentioned above.

The invention also relates to a device for implementing the process according to the invention.

This device comprises:
a tank 6 intended to contain thermally reactive adhesive 3, the viscosity of which, measured at 230° C. according to the ASTM-D3236-88 standard, is less than or equal to 40 Pa.s, and is preferably less than or equal to 30 Pa.s at 200° C. said tank 6 being heated by any appropriate means so as to keep the adhesive 3 in the molten state, and having at least one opening;
a roll 7 rotating about its axis of symmetry X, said roll 7 being arranged and positioned relative to the tank 6 so as to be feed, continuously, owing to its rotation, with molten adhesive 3 through said opening and to continuously deposit this molten adhesive 3 onto the face A of a textile scrim 5 to be coated with adhesive; and
a conveying means (not shown) for bringing said scrim 5 substantially into contact with the roll 7.

Advantageously, the roll 7 is also heated to a temperature between, for example, 70 and 300° C., and preferably between 100° C. and 220° C.

This heating may be carried out by any known means.

Advantageously, the rotating roll 7 is arranged in such a way that any region of at least part of its lateral surface 7A is alternately in contact:
on the one hand, with the molten adhesive 3, through said opening, so that the part of the lateral surface 7A is coated with adhesive; and
on the other hand with the face A of the textile scrim 5 to be coated with adhesive, said textile scrim undergoing a longitudinal translational motion (the direction of which is indicated by the arrow 8), approximately tangential to the lateral surface 7A, so as to deposit at least some of the adhesive 3 coating said part of the lateral surface 7A onto said face A.

Preferably, as shown in FIGS. 3 and 4, the roll 7 is positioned between the opening and the face A of the scrim to be coated with adhesive 3.

The roll 7 is driven in a rotational movement (indicated by the arrow 9) about its axis of symmetry X, which gives its lateral surface 7A a certain linear speed. The conveying means, which may be of any known type (for example a conveyor belt), confers on the scrim 5 to be coated with adhesive a longitudinal translational motion with a certain speed of movement.

Preferably, the longitudinal translational motion 8 is performed with a speed of movement that is approximately equal to the linear speed of the lateral surface 7A of the roll. In this way, the amount of adhesive deposited on the warp yarns is approximately equal to the amount deposited on the weft yarns. The difference in linear speed between the lateral surface 7A of the roll 7 and the bare scrim 5 to be coated makes it possible to obtain a thickness El of adhesive on the warp yarns 1, 1′ that is different from the thickness E2 of adhesive on the weft yarns 2.

The tank 6 itself consists of a body 6C provided with a doctor blade 6A in order to calibrate the coating of the roll, that is to say to control the thickness E of adhesive being deposited on the lateral surface 7A of the rotating roll 7. A second doctor blade 6B, opposite the first, makes it possible to close off the tank 6 in cooperation with the first doctor blade 6A, during machine shutdowns.

Of course, it is conceivable to design a device employing two rolls to coat a bare scrim 5 with adhesive 3 on both its faces, whether simultaneously or not, without departing from the scope of the invention.

It is worth pointing out that, in most cases, the textile scrims are sufficiently fine for coating on a single face to suffice for obtaining a scrim coated on both its faces with adhesive.

The device according to the invention thus makes it possible to coat, for example, scrims whose width may vary from 0.2 and 5 m, at a speed of between, for example 0.4 and 150 m per minute. By controlling the linear speed differential between the roll and the scrim, that is to say by controlling the difference between the linear speed of the roll and the speed of displacement of the scrim, it is possible to control the distribution of adhesive deposition between the warp yarns and weft yarns, while still avoiding any undesirable bead.

### INDUSTRIAL APPLICABILITY

The invention is applicable from an industrial standpoint in the field of textile scrims used in particular as reinforcements or backings.

1. A textile scrim (5A) formed by a network of nonwoven crossed yarns, comprising
at least one ply of warp yarns (1, 1′); and
at least one ply of weft yarns (2), the warp yarns (1, 1′) and weft yarns (2) being bonded together by a bonding agent;
wherein said textile scrim (5A) is coated on at least one of its faces (A) with a thermally reactive adhesive (3) in order to laminate the scrim (5A) onto an external element; and
the viscosity of said adhesive (3), measured at a temperature of 230° C. according to the ASTM-D3236-88 standard, is less than or equal to 40 Pa.s.

2. The textile scrim (5A) as claimed in claim 1, wherein the textile scrim (5A) comprises at least two plies of warp yarns (1, 1′) between which said at least one ply of weft yarns (2) is interposed.

3. The textile scrim (5A) as claimed in claim 1, wherein the viscosity of said adhesive (3), measured at a temperature of 200° C. according to the ASTM-D3236-8 8 standard, is less than or equal to 30 Pa.s.

4. The textile scrim (5A) as claimed in claim 1, wherein the adhesive (3) is of the hot-melt type.

5. The textile scrim (5A) as claimed in claim 1, wherein the weft yarns (2) and/or warp yarns (1, 1′) are glass yarns.

6. The textile scrim (5A) as claimed in claim 1, wherein the weft yarns (2) and/or warp yarns (1, 1′) are polyester yarns.

7. The textile scrim (5A) as claimed in claim 1, wherein the adhesive (3) covers at least one of the faces (A) of the scrim, with a mass per unit area of between 2 and 300 g/m².

8. The textile scrim (5A) as claimed in claim 1, wherein the bonding agent is a polymeric adhesive.

9. The textile scrim as claimed in claim 1, wherein the bonding agent is formed by the thermally reactive adhesive (3).

10. A process for manufacturing a scrim as claimed in claim 1, wherein the process comprises
intersecting the warp yarns (1, 1′) with the weft yarns (2) in order to form a bare scrim (5); and
coating at least one of the faces (A) of said bare scrim (5) with thermally reactive adhesive (3), the viscosity of which, measured at a temperature of 230° C. according to the ASTM-D3236-88 standard, is less than or equal to 40 Pa.s.

11. The process as claimed in claim 10, wherein the viscosity of said adhesive (3), measured at 200° C., is less than or equal to 30 Pa.s.

12. The manufacturing process as claimed in claim 10, wherein the adhesive (3) is of the hot-melt type.

13. The process as claimed in claim 10, further comprising coating the face of the bare scrim (5) with thermally reactive adhesive (3) by passing it tangentially against at least part of the lateral surface (7A) of a rotating roll (7) coated with said adhesive (3) in a melt state.

14. The process as claimed in claim 10, wherein between the yarn intersecting step and the coating step, impregnating the bare scrim (5) with a bonding agent so as to bond the weft yarns (2) and the warp yams (1, 1′) together.

15. The process as claimed in claim 14, wherein the bonding agent is a polymeric adhesive.

16. A device for implementing the process as claimed in claim 10, the device comprising:
a tank (6) intended to contain thermally reactive adhesive (3), the viscosity of which, measured at 230^{Q}C according to the ASTM-D323 6-8 8 standard, is less than or equal to 40 Pa.s, said tank (6) being heated so as to keep the adhesive (3) in the molten state, and the tank having at least one opening;
a roll (7) rotating about its axis of symmetry (X), said roll (7) being arranged and positioned relative to the tank (6) so as to be fed, continuously, owing to its rotation, with molten adhesive (3) through said opening and to continuously deposit the molten adhesive (3) onto the face (A) of a textile scrim (5) to be coated with adhesive; and
means for bringing said textile scrim (5) substantially into contact with the roll (7).

17. The device as claimed in claim 16, wherein the rotating roll (7) is arranged in such a way that any region of at least part of its lateral surface (7A) is alternately in contact:
on the one hand, with the molten adhesive (3), through said opening, so that the part of the lateral surface (7A) is coated with adhesive (3); and
on the other hand, with the face (A) of the textile scrim (5) to be coated with adhesive, said textile scrim undergoing a longitudinal translational motion (8), approximately tangential to the lateral surface (7A), so as to deposit at least some of the adhesive (3) coating said part of the lateral surface (7A) onto said face {A}.

18. The device as claimed in claim 17, wherein the roll (7) is positioned between the opening and the face (A) of the scrim (5} to be coated with adhesive.

19. The device as claimed in claim 17, wherein the longitudinal translational motion (8) is performed at a speed that is approximately equal to the tangential speed of the lateral surface (7A) of the roll.
